(19) United States
(12) Patent Application Publication
(10) Pub. No.: US 2021/0394921 A1
(43) Pub. Date: Dec. 23, 2021

(54) MODULAR AVIONICS SYSTEM

(71) Applicant: Midwest Panel Builders LLC, Lapeet, MI (US)

(72) Inventors: Stephen Robert O'Connor, II, Lapeer, MI (US); Adam Patrick O'Connor, Lapeer, MI (US)

(21) Appl. No.: 17/352,758

(22) Filed: Jun. 21, 2021

Related U.S. Application Data
(60) Provisional application No. 63/041,371, filed on Jun. 19, 2020.

(51) Int. Cl. B64D 43/00; B60R 16/02

(52) U.S. Cl. CPC B64D 43/00; B60R 16/0215

(57) ABSTRACT

A plug and play avionics kit includes an avionics panel, the avionics panel including avionics including instrument cluster electronics, one or more aircraft engine electrical component connections, one or more line replaceable units and one or more electrical harnesses, wherein the avionics kit is configured to install in a home build aircraft and the instrument cluster electronics, one or more engine electrical components, and one or more line replaceable units are connected by the electrical harness. The avionics panel may further include an avionics tray and a rack for line replaceable units.

### CROSS REFERENCE TO RELATED APPLICATIONS

This application claims priority to U.S. Provisional Application No. 63/041,371 filed on Jun. 19, 2020, which is herein incorporated by reference in its entirety.

### BACKGROUND OF THE DISCLOSURE

### Description of the Related Art

The home aircraft builder faces great difficulty in wiring an aircraft for an electrical and avionics harness without performing the tedious work of identifying places to mount equipment. Current state of the art makes it difficult to install or remove pieces without soldering or cutting wires to do so.

All current solutions rely on the home aircraft builder themselves to locate components and provide measurements for someone to custom build a harness. Current state of the art thus leaves significant work to the home aircraft builder, and the home builder also has to make all necessary connections with the aircraft and its electrical system themselves. Thus, when home building an aircraft with a home build aircraft kit, the home aircraft builder must usually separately contract out the building and installation of the avionics portion.

Accordingly, there is a need for a ‘plug and play’ modular avionics system that takes the difficulty and guess work out of the home aircraft building process for the home aircraft builder and that provides quick and easy installation of an avionics system.

### SUMMARY OF THE INVENTION

A plug and play avionics kit includes an avionics panel, the avionics panel including avionics including instrument cluster electronics, one or more aircraft engine electrical component connections, one or more line replaceable units and one or more electrical harnesses, wherein the avionics kit is configured to install in a home build aircraft, and instrument cluster electronics, one or more engine electrical components, and one or more line replaceable units are connected by the electrical harness. The avionics panel may further include an avionics tray and a rack for line replaceable units.

Other features and aspects will be apparent from the following detailed description, the drawings, and the claims.

### BRIEF DESCRIPTION OF THE DRAWINGS

FIG. 1 shows an embodiment of an avionics tray of the disclosure.

FIG. 2 shows another embodiment of a prefabricated avionics tray.

FIG. 3 shows a block diagram of an embodiment.

FIG. 4 shows an embodiment of an avionics panel and tray of the disclosure.

FIG. 5 shows another embodiment of an avionics panel and tray of the disclosure.

FIG. 6 shows another embodiment of an avionics kit of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present invention provides a prefabricated modular avionics system that can be placed in an aircraft and hooked up with a few wires and powered on.

The present disclosure provides a complete aircraft wiring harnesses, panels, and equipment racks for a home build aircraft. In specific examples, the kits can be provided for an aircraft kit line called Sling™. In specific embodiments, there are 3 models, Sling 4™, Sling TSi™, and Sling 2™. These are example home aircraft build kits that consumers can purchase and home build an aircraft themselves.

In embodiments, a wire harness is made to size on a harness board to ensure that it will fit. This harness may have the aircraft's avionics wiring as well as the entire electrical system including wing and taillights, pitot heat wiring, and the emergency locator transmitter ELT wiring. The avionics can also include line replaceable units (LRU). When a user receives a prefabricated avionics kit, they can position it in a plane, and make appropriate connections for example at the tail, wings, control sticks, and/or flap motor. A harness may lead to a panel where there may be connectors to connect to an avionics tray and panel.

In embodiments, an avionics tray is designed and prefabricated to be disposed behind the panel. This may be where the majority of the avionics are mounted. This approach solves the problem for the home aircraft builder of finding places to mount all the necessary units and electrical components. The disclosed rack can also house all the start relays for the engine and may also have a power distribution and ground bus.

The rack may also have all the wires that will lead out to the engine compartment including the main power and ground as well as the engine backup and start leads. There may also be ground connectors that will connect to a main harness as well as connectors going to the panel. The Sling TSi tray may be different from the other Sling aircraft because of a heater system that must be worked around, however the present disclosure provides a solution.

The panel is the main point of interaction for the avionics. The panel may come completely wired with connectors ready to plug into a tray and harness connectors. In embodiments, the panel may be made of aircraft grade aluminum, powder coated, with laser etching any necessary lettering. Engine computer connectors may also be wired for lane lights, fuel pumps, and/or starting relays. The homebuilder can then fit it to a glare shield, plug in the connectors, and screw it down. In embodiments, the invention provides a complete system and greatly facilitates the process of home building an aircraft.

This system may be modular and provided in a limited number of components, for example, three components. A modular design that comes in a limited number of components makes it easy to install. A prefabricated mounting solution also mounts all required units and electrical components that normally have to be located in many different places. This system takes the guess work out of the avionics and electrical systems for a home aircraft and allows a home aircraft builder to focus on other aspects of building the aircraft.

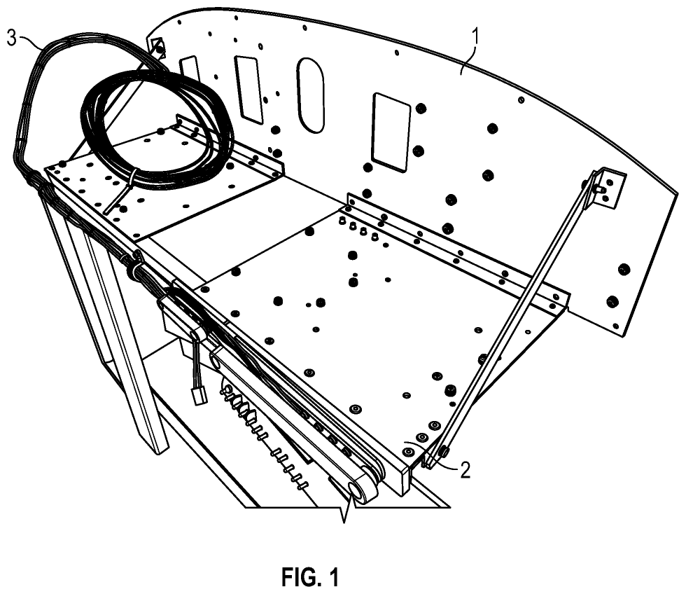

FIG. 1 shows an embodiment of an avionics panel and tray of the disclosure without associated avionics. FIG. 1 shows avionics panel 1, avionics tray 2, and wiring 3 which can be used for electrical components attached to the avionics tray and panel. In embodiments, the avionics tray will be located on the opposite side of the avionics panel from the pilot.

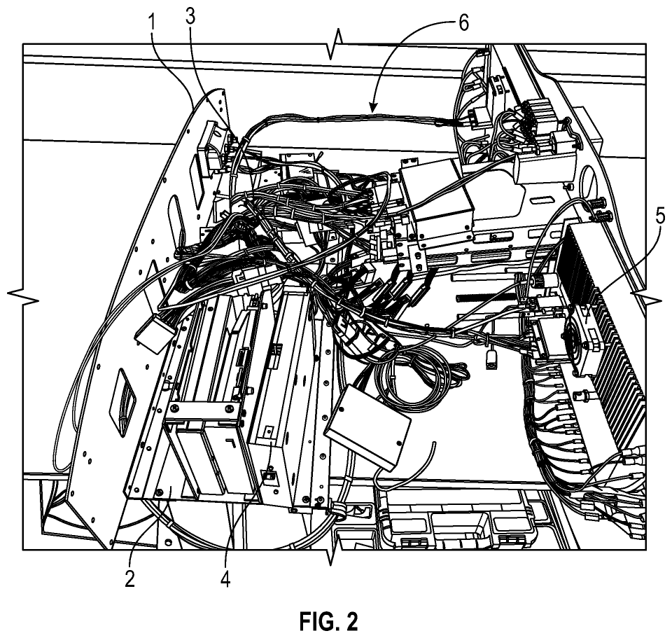

FIG. 2 shows another embodiment of a prefabricated avionics panel and tray with avionics. FIG. 2 shows avionics panel 1, avionics tray 2, wiring 3, line replaceable unit 4, fan 5, and additional wiring and electrical components 6.

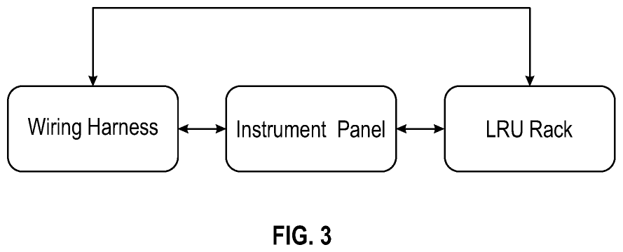

FIG. 3 shows a block diagram of an embodiment of the disclosure. FIG. 3 shows the three main modules of an embodiment of an avionics kit. FIG. 3 shows wiring harness connected to an instrument panel connected to an LRU rack. Interconnection may consist of various power carrying communications wires and cables.

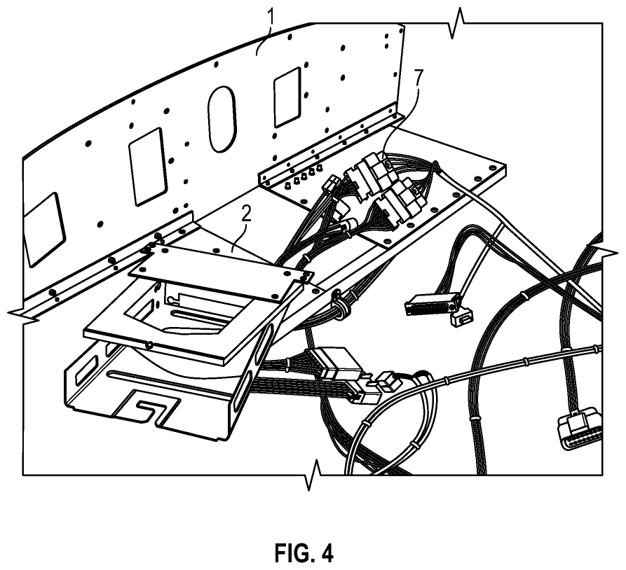

FIG. 4 shows an embodiment of an avionics panel and tray of the disclosure. FIG. 4 additionally shows wiring harness 7. In embodiments, a wiring harness may facilitate connecting multiple electrical components with the avionics panel and tray.

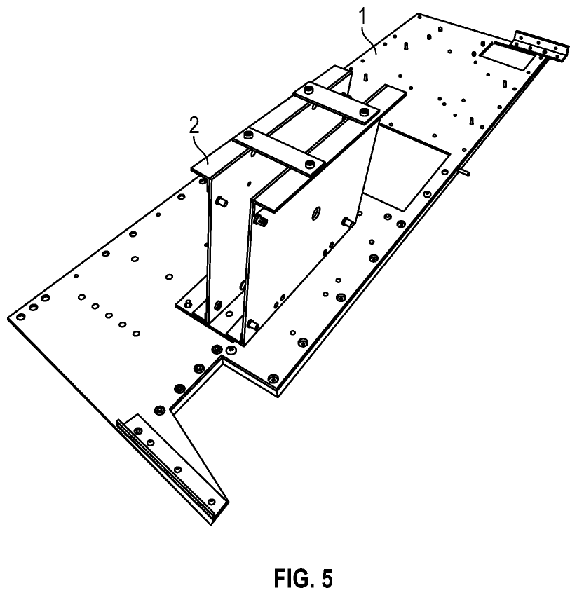

FIG. 5 shows another embodiment of an avionics panel and tray of the disclosure. FIG. 5 shows avionics panel 1 and avionics tray 2. In this embodiment, the avionics panel and tray may be part of a kit adapted for the Sling 2 home aircraft build kit.

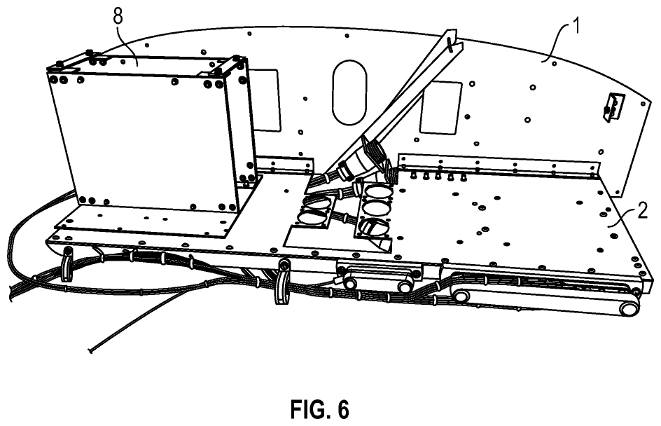

FIG. 6 shows another embodiment of an avionics kit of the disclosure. FIG. 6 shows avionics panel 1, avionics tray 2, and a line replaceable unit (LRU) rack 8.

A homebuilt aircraft as referred to herein typically refers to homebuilt aircraft, also known as amateur-built aircraft or kit planes and are typically constructed by persons for whom this may be a hobby or for home, farm, or individual use as examples. Such aircraft may be constructed from plans, or from assembly kits, tray, and rack without associated avionics. See e.g., Home Built Aircraft, Wikipedia, The Free Encyclopedia, last edited: 23 Mar. 2021, herein incorporated by reference.

Sling Aircraft™ are specific examples of the genre of home build aircraft and include several models including Sling 2™, Sling 4™, and Sling TSI™. See e.g., Sling Aircraft 2™, Wikipedia, The Free Encyclopedia, last edited 8 Mar. 2021, herein incorporated by reference; Sling Aircraft 4™, Wikipedia, The Free Encyclopedia, last edited 23 May 2021, herein incorporated by reference; and Sling Aircraft TSI™, Wikipedia, The Free Encyclopedia, last edited 8 Mar. 2021, herein incorporated by reference.

A line-replaceable unit of the disclosure is a modular component of an aircraft that is designed to be replaced quickly and typically at an operating location. See e.g., Line Replaceable Unit, Wikipedia, The Free Encyclopedia, last edited: 3 Aug. 2020, herein incorporated by reference.

A harness with cable harness as referred to herein is typically an assembly of electrical cables or wires which transmit signals or electrical power. See e.g., Cable Harness, Wikipedia, The Free Encyclopedia, last edited: 9 Mar. 2021, herein incorporated by reference.

Avionics as referred to herein generally include electronic systems used on aircraft. Avionic systems may include instrument cluster electronics, communications, navigation, the display and management of multiple systems, and the hundreds of systems that are fitted to an aircraft to perform individual functions. See Avionics, Wikipedia, The Free Encyclopedia, last edited 6 Jun. 2021, herein incorporated by reference.

The term ‘plug and play’ as referred to herein generally means a hardware component or components that can be connected to a system without the need for additional configuration or user intervention relating to, for example, compatibility of the component with the existing system. The term has frequently been used in the computer arts and has been extended into other areas as well. In this case, plug-and-play refers to the ability to install an avionics kit of the disclosure into a home-built aircraft and connect a variety of electrical components including instrument panel electronics, transponder, lighting, heating, etc., by plugging the various components into the avionics kit including panel and one or more trays through an electrical harness.

While this disclosure includes specific examples, it will be apparent after an understanding of the disclosure of this application has been attained that various changes in form and details may be made in these examples without departing from the spirit and scope of the claims and their equivalents.

1. A plug and play avionics kit comprising:
an avionics panel, the avionics panel comprising:
avionics including instrument cluster electronics;
one or more aircraft engine electrical component connections
one or more line replaceable units; and
one or more electrical harnesses,
wherein the avionics kit is configured to install in a home build aircraft and the instrument cluster electronics, one or more engine electrical components, and one or more line replaceable units are connected by an electrical harness.

2. The plug and play avionics kit of claim 1, wherein the avionics panel comprises an avionics tray.

3. The plug-and-play avionics kit of claim 2, wherein the avionics tray includes a line replaceable unit rack.

4. The plug-and-play avionics kit of claim 1, wherein the avionics panel and avionics tray comprise aircraft grade aluminum.

5. The plug-and-play avionics kit of claim 1, wherein the avionics comprise emergency locator transmitter wiring and components and engine computer electronics wiring and components.

6. Plug-and-play avionics kit of claim 1, wherein the avionics comprise wing and taillights wiring and pitot heat wiring.
